(19) United States
(12) Patent Application Publication
(10) Pub. No.: US 2012/0313957 A1
(43) Pub. Date: Dec. 13, 2012

(54) Staged Animated Transitions for Aggregation Charts

(75) Inventors: Danyel A. Fisher, Seattle, WA (US); Steven M. Drucker, Bellevue, WA (US); Roland Fernandez, Woodinville, WA (US)

(73) Assignee: MICROSOFT CORPORATION, Redmond, WA (US)

(21) Appl. No.: 13/156,364

(22) Filed: Jun. 9, 2011

(51) Int. Cl. G06T 13/80; G09G 5/02

(52) U.S. Cl. 345/589; 345/440; 345/440.2

(57) ABSTRACT

A chart animation module is described herein that animates a transformation of a first chart into a second chart. The transformation, for instance, can correspond to a grouping-type transformation, a filtering-type transformation, or a transposing-type transformation. In one implementation, the chart animation module performs the transformation in such a manner so as to create a visual perception that there is a conservation of area and preservation of identify of constituent elements that are moved from the first chart to the second chart. The chart animation module can move the constituent elements in the form of blocks or particles.

### BACKGROUND

Various computer-implemented tools exist for presenting data in the form of charts. The computer-implemented tools also commonly include mechanisms that allow a user to modify an original chart into an updated chart. Efforts have been made to make these types of tools easy to understand and interact with, but there is room for improvement with respect to this aspect of such tools.

### SUMMARY

A chart animation module is described herein for animating transitions between chart states. The chart animation module operates by first receiving an instruction to modify a first chart into a second chart. The first chart shows a plurality of first aggregate results, while the second chart shows a plurality of second aggregate results. The chart animation module then transforms the first chart into the second chart in one or more animated stages by moving a collection of constitute elements from the first chart to the second chart. More specifically, the chart animation module performs this transformation in a manner that gives an observer the perception that there is a conservation of area in the constituent elements that are transitioned from the first chart to the second chart. Further, the chart animation module preserves the identity of the constituent elements in the course of their movement. By virtue of this characteristic, the observer can more readily visually track the changes that have been made to the first chart to produce the second chart.

According to another illustrative aspect, the instruction that is received is a grouping instruction. Here, the transformation involves adding component aggregated results (e.g., component bars) to the first aggregate results to produce the second aggregate results. An ungrouping instruction can perform the reverse operation.

According to another illustrative aspect, the instruction that is received is a filtering instruction. Here, the transformation involves removing a group of elements from the first aggregate results to produce the second aggregate results. For instance, the group of elements that is removed may comprise a row or column of constituent elements. A “filtering in” operation can perform the opposite behavior, e.g., by adding a row or column of constituent elements.

According to another illustrative aspect, the instruction that is received is a transposing instruction. Here, the transformation involves changing a first organization of categories in the first aggregate results to a second organization of categories in the second aggregate results.

According to another illustrative aspect, the chart animation module depicts the movement of constituent elements as movement of blocks. Each block represents an aggregate result in the first chart. Alternatively, the chart animation module depicts the movement of constituent elements as a movement of particles. That is, the chart animation module can decompose each constituent element in the first chart into a plurality of particles and move the constitute elements as a swarm of particles.

According to another illustrative aspect, the transformation of the first chart into the second chart can be performed in an in-place fashion (that is, in a single display area), or by moving the constituent elements from a first display area (associated with the first chart) to a second display area (associated with the second chart).

According to another illustrative aspect, the transformation of the first chart into the second chart is governed by a selectable movement schedule. The movement schedule defines a timing at which constituent elements are moved from the first chart to the second chart.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative chart animation module for animating transitions between chart states.

FIG. 2 shows a first implementation of the chart animation module.

FIG. 3 shows a second implementation of the chart animation module.

FIG. 4 shows one implementation of a particle-based transposing module that may be used in the chart animation module of FIG. 1.

FIG. 5 shows a grouping-type transformation that can be performed by the chart animation module of FIG. 1.

FIG. 6 shows a column-based filtering transformation that can be performed by the chart animation module of FIG. 1.

FIG. 7 shows a row-based filtering transformation that can be performed by the chart animation module of FIG. 1.

FIG. 8 shows a transposing-type transformation that can be performed by the chart animation module of FIG. 1. Here, the transformation moves constituent elements from a first display area (associated with a first chart) to a second display area (associated with a second chart).

FIG. 9 shows an in-place transposing-type transformation that can be performed by the chart animation module of FIG. 1.

FIG. 10 shows another transposing-type transformation that can be performed by the chart animation module of FIG. 1. Here, the chart animation module decomposes each constituent element in the first chart into a plurality of particles, and then moves the constituent element in participle-by-particle fashion.

FIG. 11 shows an interface that allows a user to specify a manner in which a first chart is to be modified into a second chart.

FIG. 12 shows an interface for configuring a manner in which the chart animation module (of FIG. 1) performs animation.

FIG. 13 shows an illustrative procedure that sets forth one manner of operation of the chart animation module of FIG. 1.

FIG. 14 shows illustrative computing functionality that can be used to implement any aspect of the features shown in the foregoing drawings.

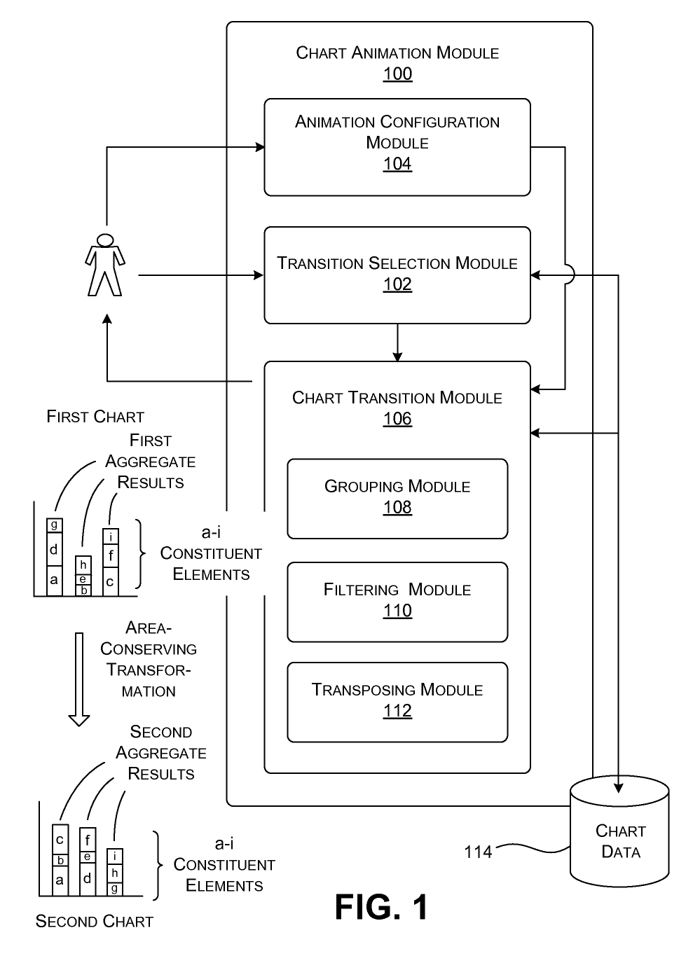

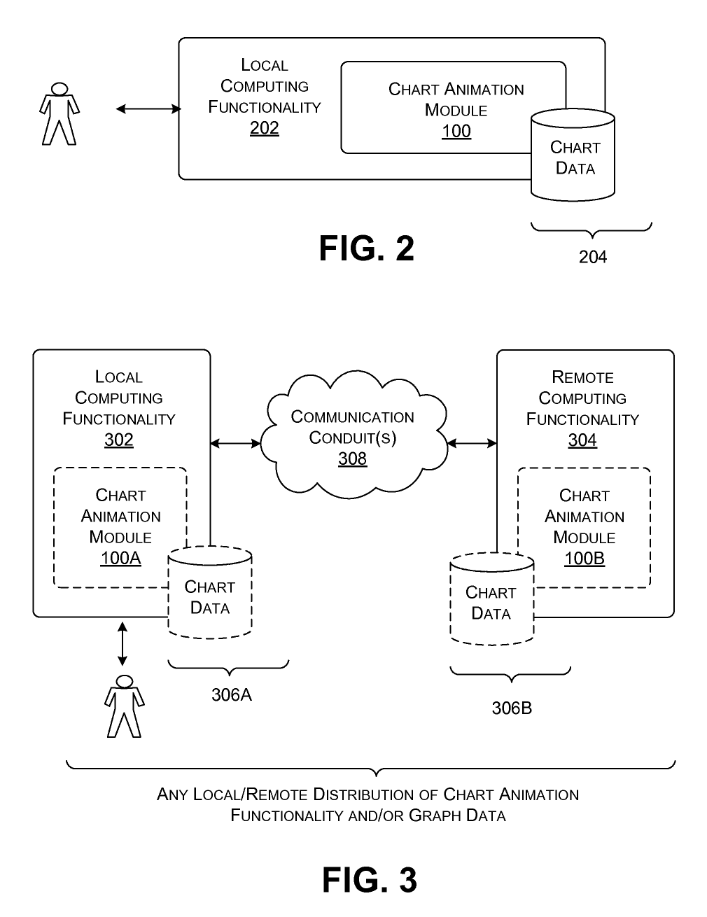

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative chart animation module for animating transitions between chart states. Section B describes illustrative methods which explain the operation of the chart animation module of Section A. Section C describes illustrative computing functionality that can be used to implement any aspect of the features described in Sections A and B.

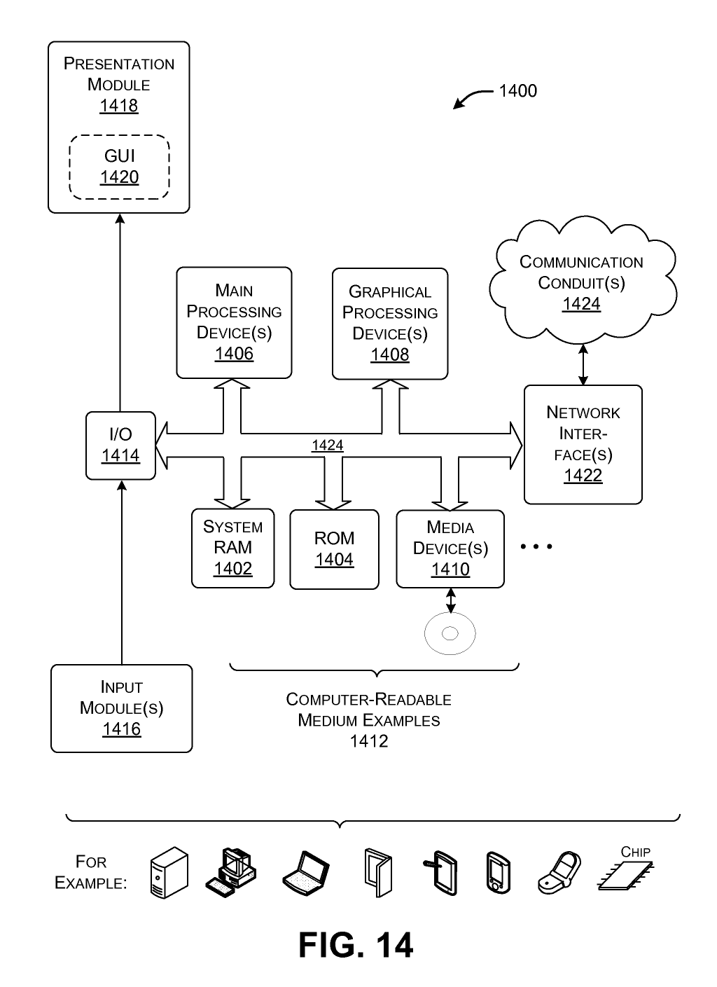

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 14, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations.

A. Illustrative Chart Animation Module

FIG. 1 shows a chart animation module 100 for animating the transformation of a first chart into a second chart. The first chart and the second chart draw from the same chart data, but provide different representations of the chart data. That is, the first chart presents first aggregate results and the second chart presents second aggregate results. Each aggregate result, in turn, includes a count or a sum of some measure associated with the chart data (such as revenue in the examples to follow).

For example, the first chart and the second chart may each comprise stacked bar charts. A stacked bar chart includes at least two axes. A first axis identifies the respective heights of the bars, mapped to some measure (such as revenue). A second axis organizes the bars according to a first dimension of categories. The stacked bar chart also partitions the bars into component bars based on a second dimension of categories. The height of each component bar represents a component aggregate result.

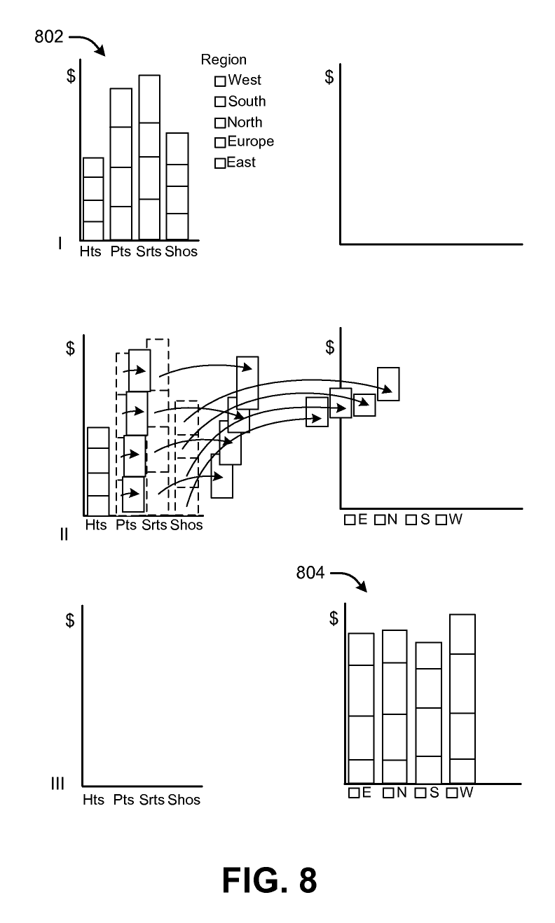

For example, in the examples which follow (e.g., in FIG. 8), a first dimension of categories may represent different products, while the second dimension of categories may represent different regions. The overall height of an individual bar represents revenue associated with a particular product. The relative height of a component bar within a particular product bar represents the revenue within a particular region (for that product). In one type of transformation, the chart animation module 100 can swap the first dimension of categories with the second dimension of categories. This yields a second chart that arranges region categories along an axis, and which partitions the individual region bars into component bars associated with different respective categories of products.

However, the principles described herein extend to other types of charts that represent aggregate results. Further, although the examples presented herein show only two axes, the principles set forth herein extend to charts having more than two axes (such as three-dimensional charts).

Each aggregate result (e.g., each bar) can be viewed as being composed of a plurality of constituent elements. For example, each bar in a stacked bar chart is composed of one or more component bars associated with different categories. By way of overview, the chart animation module 100 performs animation by moving at least some of the constituent parts from the first chart to the second chart. In a first scenario, the first chart is associated with a first display area, while the second chart is associated with a second display area. In that case, transformation involves moving component bars from a first display area to a second display area. In a second scenario, the transformation occurs in place, such that the first chart and the second chart are associated with the same display area.

In performing the transition, the chart animation module 100 creates the visual perception that constituent parts in the first chart are reassembled in the second chart without loss or gain of area in the constituent parts in the course of the transition, and without change of identity of the constituent parts in the course of the transition. In a first example, the chart animation module 100 achieves this effect by preserving the size and shape of rectangular blocks associated with the first chart as they migrate to the second chart. In a second example, the chart animation module 100 achieves this effect by decomposing each rectangular block into a plurality of particles and sweeping the particles from the first chart to the second chart. The margin of FIG. 1 shows an example which depicts some of the terminology developed above, which is used throughout this disclosure.

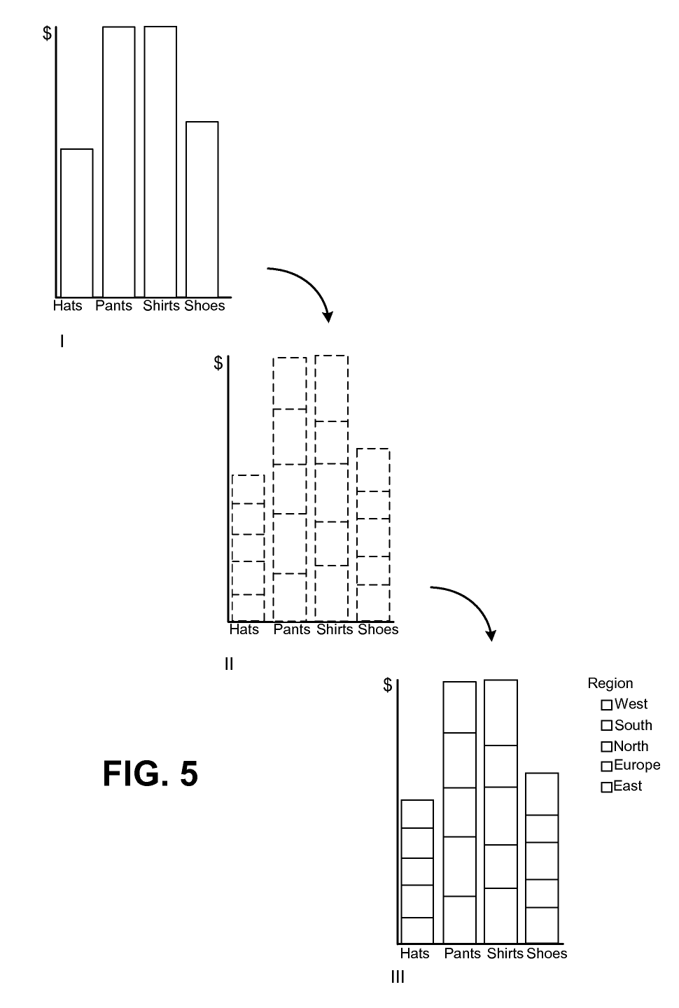

As shown in FIG. 1, the chart animation module 100 includes (or can be conceptualized as including) a plurality of functional blocks. A transition selection module 102 receives instructions from the user regarding a modification to be performed on the first chart to produce the second chart. A first instruction instructs the chart animation module 100 to perform a grouping-type transformation. In this type of transformation, the chart animation module 100 partitions the first aggregate results in the first chart to produce the second aggregate results in the second chart. That is, for example, the grouping-type transformation breaks up the bars in the first chart, yielding the component bars in the second chart. FIG. 5, described below, shows an example of a grouping-type transformation. A counterpart ungrouping operation can be performed to remove component bars that have already been added to a chart.

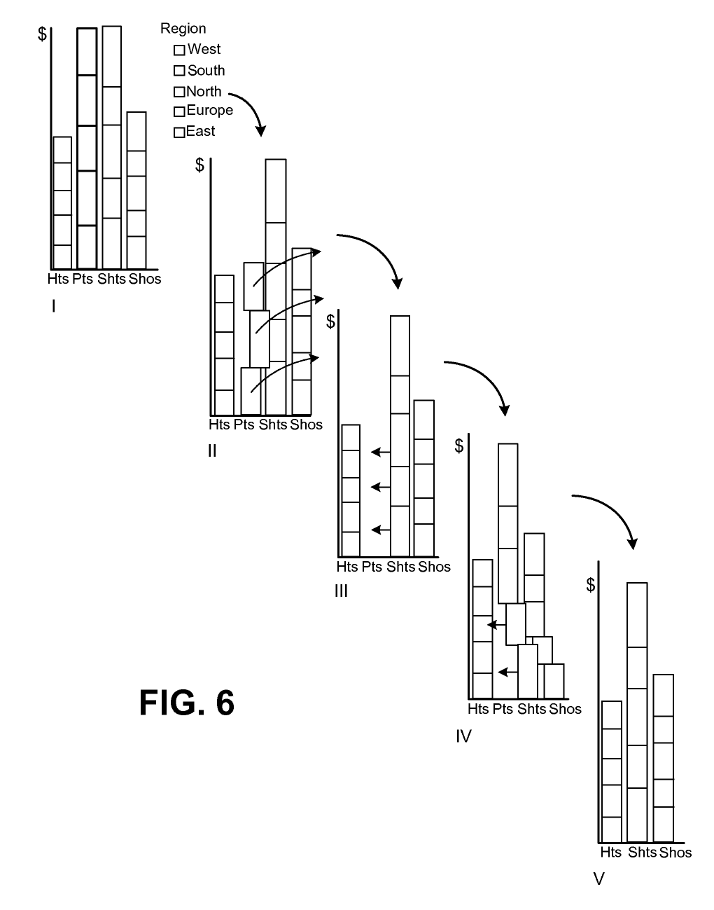

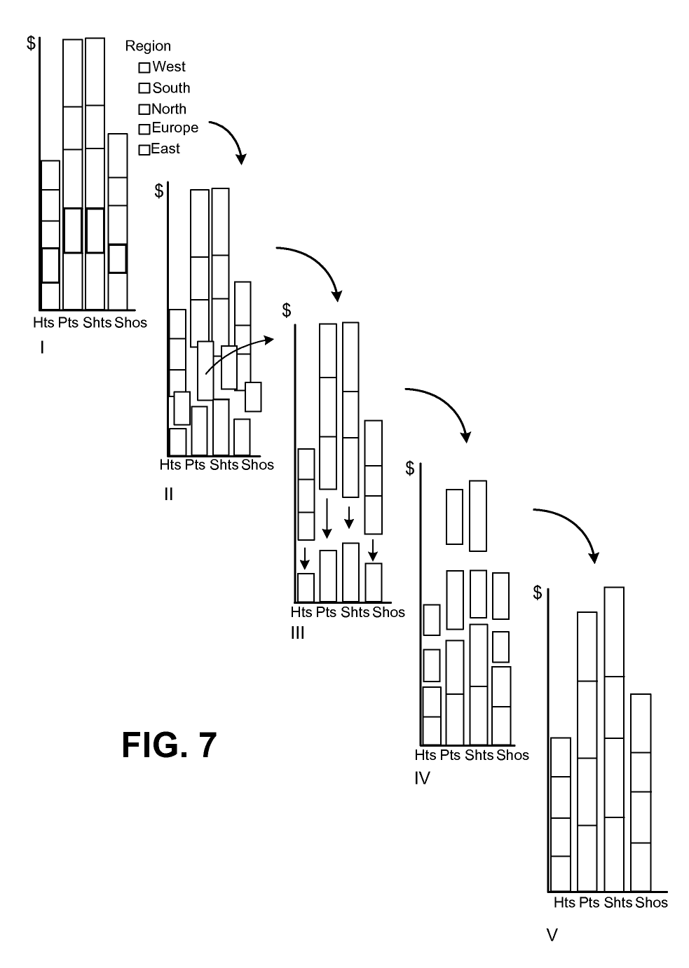

A second instruction instructs the chart animation module 100 to perform a filtering-type transformation. In this transformation, the chart animation module 100 removes a group of constituent elements from the first aggregate results to produce the second aggregate results. For example, the filtering-type transformation removes a column or row or constituent block elements in the first chart to produce the second chart. FIGS. 6 and 7, described below, show examples of filtering-type transformations. A similar operation can be performed to insert new constituent elements into a chart.

A third instruction instructs the chart animation module 100 to perform a transposing-type transformation. In this transformation, the chart animation module 100 transitions from a first manner of organizing group categories in the first aggregate results to a second manner of organizing group categories in the second aggregate results. For example, consider the above example in which a first dimension of categories is used to define individual bars in a stacked bar chart, and a second dimension of categories is used to partition individual bars into component bars; here, the transposing-type transformation can swap the first dimension of categories (such as product categories) with a second dimension of categories (such as region categories). FIGS. 8-10, to be described below, show examples of transposing-type transformations.

However, the principles described herein extend to other types of transformations besides the illustrative three types of transformations described herein.

An animation configuration module 104 configures the chart animation module 100 to transition between the first chart and the second chart in a particular manner. For example, the animation configuration module can allow a user (or other agent) to select a movement schedule. The movement schedule defines a timing at which constituent elements are moved from the first chart to the second chart. For example, a first movement schedule organizes movement of the constituent elements on an element-by-element basis. A second movement schedule organizes movement of the constituent elements by moving respective rows of constituent elements. A third movement schedule organizes movement of the constituent elements by moving respective columns of constituent elements, and so on. Other configuration options will be set forth in the context of the explanation of FIG. 12.

A chart transition module 106 performs the transformation of the first aggregate results in the first chart to the second aggregate results in the second chart. For example, the chart transition module 106 includes a grouping module 108 for performing a grouping-type transformation, a filtering module 110 for performing a filtering-type transformation, and a transposing module 112 for performing a transposing-type transformation.

A data store 114 (or plural such data stores) may store chart data. The chart animation module 100 draws from the chart data to present the first chart and the second chart. As noted above, the same chart data underlies the first chart and the second chart (because the first chart and the second chart represent different visual depictions of the chart data).

Advancing to FIG. 2, this figure shows one implementation of the chart animation module 100 of FIG. 1. In this case, local computing functionality 202 implements the chart animation module 100, e.g., as an application module that is locally stored by the local computing functionality 202. The local computing functionality 202 may represent any type of computing device, such as a personal computer, a computer workstation, a lap top computer, a game console device, a set-top box device, a personal digital assistant (PDA), a mobile telephone, a tablet-type computer, an electronic book-reader device, and so on. In this implementation, the local computing functionality 202 can interact with chart data stored in one or more local and/or remote data stores 204.

FIG. 3 shows another implementation of the chart animation module 100. In this case, the chart animation module 100 and the chart data can be distributed between local computing functionality 302 and remote computing functionality 304 in any manner. For example, in one scenario, the local computing functionality 302 can provide a chart animation module 100A, which has access to local chart data store(s) 306A and/or remote chart data store(s) 306B. In another scenario, the remote computing functionality 304 can provide a chart animation module 100B, which has access to chart data store(s) 306A and/or chart data store(s) 306B. In another scenario, the chart animation module module can be implemented by a combination of the locally-implemented chart animation module 100A and the remote-implemented chart animation module 100B, with access to any of the chart data store(s) 306A and/or the chart data store(s) 306B. Still other implementations are possible.

In any of these scenarios described above with reference to FIG. 3, the user may interact with the chart animation module (100A and/or 100B) via the local computing functionality 302. The local computing functionality 302 may represent any type of computing device described above (with respect to FIG. 2). The remote computing functionality 304 may represent one or more server computers and associated data stores, etc., provided at a central location or distributed over plural locations. A communication conduit 308 connects the local computing functionality 302 and the remote computing functionality 304. The communication conduit 308 represents any type of local area network, any type of wide area network (e.g., the Internet), any type of point-to-point connection, and so on, or any combination thereof

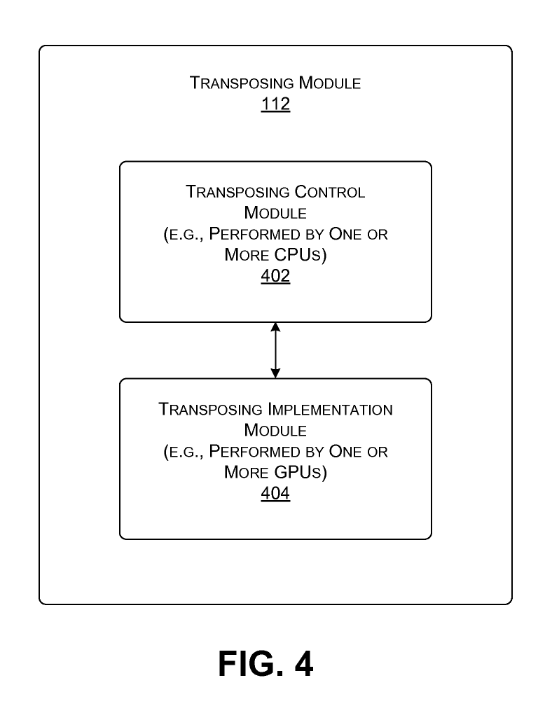

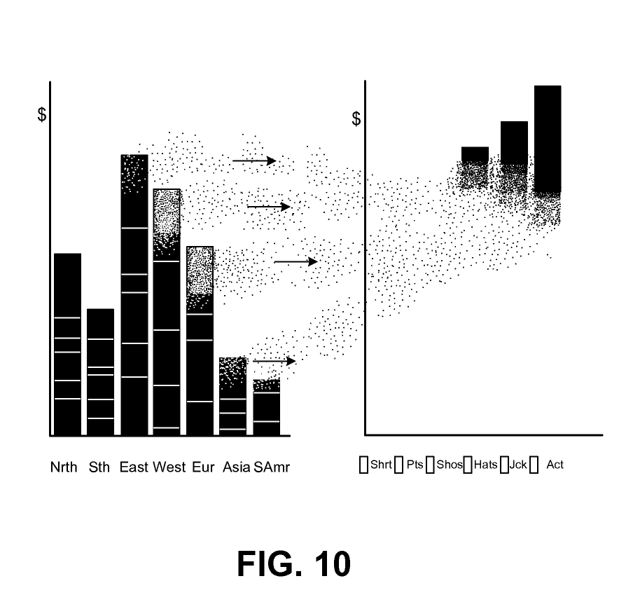

FIG. 4 shows one implementation the transposing module 112 of FIG. 1. In this implementation, the transposing module 112 moves a plurality of constituent elements in the first chart to appropriate positions in the second charts by breaking up each of the plurality of constituent elements into a plurality of particles. The transposing module 112 then moves the constituent elements by sweeping the particles from the first chart to the second chart (as will be illustrated below with respect to FIG. 10).

In one implementation, the transposing module 112 uses two hierarchical processing components to perform the movement of particles in the above-described manner. That is, a transposing control module 402 creates an image of the first chart and defines the meta-characteristics of the transposing action to be performed on the first chart to produce the second chart. A transposing implementation module 404 executes the actual movement of particles, e.g., by defining individual particle locations and moving the individual particles in a swarm of particle migration. Once the particles have been moved to the second chart, the transposing control module 402 can replace the individual particles with consolidated blocks. In one implementation, or one more main processing devices (such as one or more CPUs) perform the functions of the transposing control module 402, while one or more graphical processing units perform the functions of the transposing implementation module 404. The transposing module 112 allocates the computation-intensive movement of particles to the transposing implementation module 404 so as to not overwhelm the transposing control module 402. For example, in some technical environments, the transposing control module 402 may not be able to perform the fine-grained movement of the particles in real time.

FIGS. 5-10 show examples of different types of chart transformations that can be performed by the chart animation module 100. To begin with, FIG. 5 shows a grouping-type transformation. In this transformation, the chart animation module 100 adds partitions to the bars in a first chart (represented by state I). This yields a second chart (represented by state III).

In one approach, the chart animation module 100 produces the grouping-type transformation by superimposing the component bars on top of the original bars in the first chart. This superimposing action may be performed over a prescribed time span (e.g., 2-4 seconds), over which the component bars become increasingly visible. State II represents a state in that is intermediary between the first state I (in which the component bars are not visible at all) and the third state III (in which the component bars are fully visible). This type of transformation preserves the size, area, and identity of the original bars in the first chart; this is because the component bars represent component parts of the original bars that are carved out of the original bars. Although not illustrated, the chart animation module 100 can alternatively produce the grouping-type transformation by sweeping the component bars into the first chart, e.g., as if originating from some location(s) off screen.

The chart animation module 100 can also perform the grouping-type transformation in reverse by removing partitions that have been added to the bars in the first chart. Or the chart animation module 100 can replace (or supplement) the grouping criterion that is used to partition the bars in the first chart with another grouping criterion.

FIG. 6 shows a filtering-type transformation. In this transformation, the chart animation module 100 removes a column of constituent elements in a first chart (as represented by state I). This yields a second chart (as represented by state V). This type of transformation occurs in an in-place fashion, e.g., whereby an action performed on the first chart (in state I) produces the second chart (in state V) in a single display area.

In one approach, the chart animation module 100 produces the filtering-type transformation by removing a column in two stages. In a first stage, the chart animation module 100 sweeps away the column from the first chart (as represented by state II of FIG. 6). That is, the column appears to fly off screen. In a second stage, the chart animation module 100 collapses the remaining columns to fill in the space left by the column that has been removed (as represented by states III and IV of FIG. 6). In this movement, the subset of component bars that transition from the first chart to the second chart preserve their respective sizes, areas, and identities.

The chart animation module 100 can also perform the filtering-type transformation in reverse by adding a column into a first chart to create the second chart. In this case, the column that is added appears to sweep in from some location off screen; that new column then shifts the existing columns to make room for the new column.

FIG. 7 shows another filtering-type transformation. In this transformation, the chart animation module 100 removes a row of constituent elements in a first chart (as represented by state I). This yields a second chart (as represented by state V). This type of transformation occurs in an in-place fashion, e.g., whereby an action performed on the first chart (in state I) produces the second chart (in state V).

In one approach, the chart animation module 100 produces the filtering-type transformation by removing a row in two stages. In a first stage, the chart animation module 100 sweeps away the row from the first chart (as represented by state II of FIG. 7). That is, the row appears to fly off screen. In a second stage, the chart animation module 100 collapses the remaining rows to fill in the space left by the row that has been removed (as represented by states III and IV of FIG. 7). In this movement, the subset of component bars that transition from the first chart to the second chart preserve their respective sizes, areas, and identities.

The chart animation module 100 can also perform the filtering-type transformation in reverse by adding a row into a first chart to create the second chart. In this case, the row that is added appears to sweep in from some location off screen; the new row then shifts the existing rows to make room from the new row.

FIG. 8 shows a transposing-type transformation. In this transformation, the chart animation module 100 changes a first manner of presenting categories in a first chart 802 (in state I) to a second manner of presenting categories in a second chart 804 (in state III). More specifically, the first chart 802 organizes bars using a product dimension along its horizontal axis; further, it partitions bars using a region dimension. The second chart 804 organizes bars using the region dimension along its horizontal axis; further, it partitions bars using a product dimension. In a first scenario, this type of transformation occurs by moving constituent elements from the first chart 802, which is presented in a first display area, to the second chart 804, which is presented in a second display area. The left part of FIG. 8 represents instances of the first display area in various states, while the right part of FIG. 8 represents instances of the second display area in various states.

In one approach, the chart animation module 100 produces the transposing-type transformation by moving constituent elements in the first chart 802 to appropriate positions in the second chart 804. The chart animation module 100 can perform this operation, in turn, using different selectable movement schedules. In the illustrated case of FIG. 8, the chart animation module 100 sweeps out constituent elements from the first chart 802 into the second chart 804 on a column-by-column basis. Alternatively, the chart animation module 100 can perform this operation on a row-by-row basis, or on an element-by-element basis, and so on. Still other configuration parameters (described below) control the manner in which this operation may be performed. Generally, in this movement, the component bars that transition from the first chart 802 to the second chart 804 preserve their respective sizes, areas, and identities.

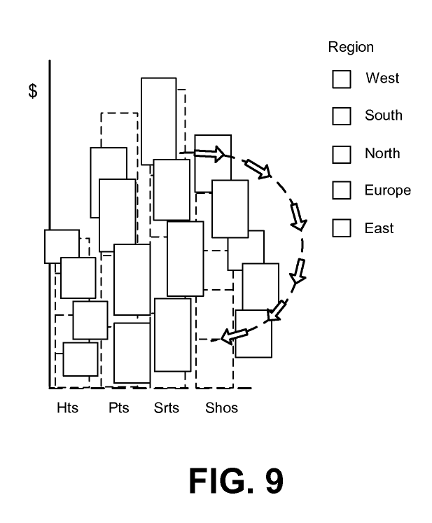

FIG. 9 shows another way of performing a transposing-type transformation. Here, the chart animation module 100 performs the movement of constituent elements in an in-place manner, rather than from a first display area to a second display area (as in FIG. 8). In one approach, the chart animation module 100 can perform this in-place movement by rotating the constituent elements from their original positions (associated with the first chart) to their destination positions (associated with the second chart). The arrows in FIG. 9 depict this general manner of rotation. Once again, in this movement, the component bars that transition from the first chart to the second chart preserve their respective sizes, areas, and identities.

FIG. 10 shows another way of performing a transposing-type transformation. Here, the chart animation module 100 breaks up each constituent element into a plurality of particles. The chart animation module 100 then sweeps the particles from respective first original positions in the first chart to final positions in the second chart, e.g., using a drifting sand metaphor. In this movement, the component bars that transition from the first chart to the second chart preserve their respective sizes, areas, and identities; this is because the constant-sized particles that are removed from the first chart are added to the second chart, there being no loss or gain of particles along the way. For example, if each particle represents a quantum of revenue, the total revenue of the second chart equals the total revenue of the first chart.

In all of the above cases, an observer will generally perceive that the chart animation module 100 achieves conservation of area between the first chart and the second chart (that is, with respect to whatever subset of parts in the first chart are preserved in the second chart, because some parts may be effectively deleted from the first chart). However, in certain cases, the chart animation module 100 can scale the charts in such a manner that conservation of area is not achieved from a literal perspective (e.g., a mathematical perspective).

For example, consider the case in which a user filters an original chart by adding categories or removing categories. In the case of adding categories, the chart animation module 100 can zoom out to produce the second chart so as to provide enough space to effectively present the new categories. In the case of removing categories, the chart animation module 100 can zoom in to effectively remove empty space that has been left by the removal of the categories.

In another scenario, consider the case of FIG. 8 in which the chart animation module 100 transitions from a first stacked bar chart to a second stacked bar chart. Before the transition, the chart animation module 100 can display only the first chart (shown in the left part of FIG. 8). When the transition commences, the chart animation module 100 can zoom out to display both the first chart and the second chart (shown in the left and right parts of FIG. 8, respectively). When the transition terminates, the chart animation module 100 can zoom in again to display just the second chart (shown in the left part of FIG. 8). Alternatively, the chart animation module 100 can adopt other protocols for zooming in and out in the course of chart transposition; further, the user may be given the opportunity to select a desired zooming behavior that will accompany chart transposition.

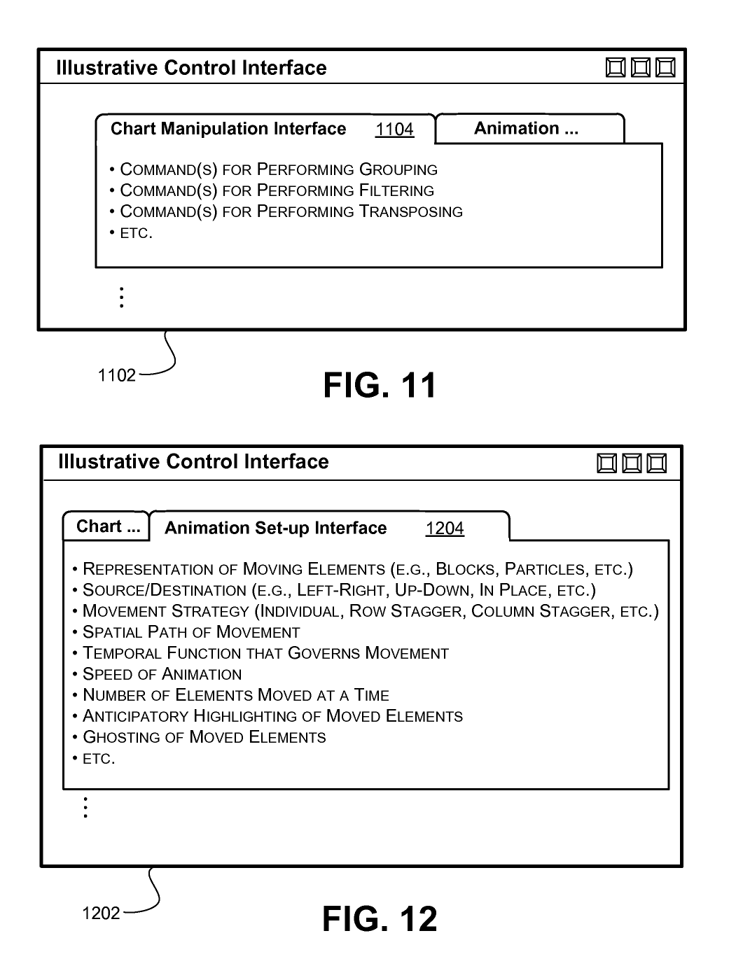

FIG. 11 shows a high-level view of an illustrative user interface presentation 1102 which provides a chart manipulation interface 1104. The chart manipulation interface 1104 includes various commands that a user may invoke to produce different types of chart manipulation operations. Illustration transformations include a grouping-type transformation, a filtering-type transformation, and a transposing-type transformation.

FIG. 12 shows a high-level view of an illustrative user interface presentation 1202 which provides an animation set-up interface 1204. The animation set-up interface 1204 allows a user to make various selections which govern the manner in which the chart animation module 100 transforms the first chart into the second chart. More specifically, in one implementation, the animation set-up interface 1204 can empower any end user to govern the manner in which movement is performed. In another case, the animation set-up interface 1204 may allow a developer to select the manner in which movement is performed; thereafter, at least some of the configuration options are fixed for the end user.

For example, a first selection may govern whether the chart animation module 100 represents the constitute elements as blocks (as in FIGS. 5-9) or as particles (as in FIG. 10).

A second selection governs the manner in which the first chart is displayed relative to the second chart. For example, in FIG. 5, the chart animation module 100 transforms the first chart into the second chart in a single display area (e.g., in an in-place fashion). In contrast, in FIG. 8, the chart animation module 100 presents the first chart in a first display area and the second chart in a second display area. Here, the first display area occurs to the left of the second display area, so that the movement of constituent elements occurs from left to right. But it is also possible to configure the chart animation module 100 so that movement occurs from right to left, from top to bottom, from bottom to top, and so on.

A third selection defines a movement strategy that is employed to move constituent elements from the first chart to the second chart. More specifically, as illustrated in some of the drawings, the chart animation module 100 can move the constituent elements (e.g., in blocks or participle form) in a staggered order. For example, a first movement schedule organizes movement of the constituent elements on an element-by-element basis, e.g., by commencing movement of hypothetical elements A, B, and C, in staged temporal order. A second movement schedule organizes movement of the constituent elements on a row-by-row basis, e.g., by commencing movement of hypothetical rows A, B, and C, in staged temporal order. A third movement schedule organizes movement of the constituent elements on a column-by-column basis, e.g., by commencing movement of hypothetical columns A, B, and C, in staged temporal order, and so on.

A fourth selection defines the spatial paths that constituent elements take when transitioning from the first chart to the second chart. For example, the chart animation module 100 can specify that the constituent elements follow straight-line paths (or curved-line paths) from their respective original positions in the first chart to their respective destination positions in the second chart. If in-place rotation is used, the chart animation module 100 can define whether rotation occurs in the clockwise direction or the counterclockwise direction, and so on.

A fifth selection defines the temporal function (or functions) that govern the movement of constituent elements from the first chart to the second chart. For example, in one temporal function, the chart animation module 100 can move the constituent elements at constant speed from their respective source positions to their destination positions. In another case, the chart animation module 100 can use an “ease-in ease-out” approach to move constituent elements. In this option, from a start of movement, the chart animation module 100 can increase the speed of movement for each constituent element, slowly at first. Once a prescribed speed is achieved, the chart animation module 100 can decrease the speed of movement until the constituent element slowly settles into its destination position. The chart animation module 100 can adopt this strategy to avoid the appearance of abrupt (“jerky”) movement.

A sixth selection defines a speed of movement of the constituent elements. A user can pick whatever speed is deemed to best promote understanding of chart movement. If a temporal function is used to define the movement of constituent elements, the speed may define a maximum speed of the constituent elements in the course of their movement, or an overall time interval in which movement occurs.

A seventh selection defines a number of constituent elements that are moved at any given time. For example, on one extreme, the chart animation module 100 can place each constituent element (in the second chart) without starting the movement of the next constituent element. By setting a higher number, the chart animation module 100 place two or more constituent elements in transit at any given time. For example, as shown in state II of FIG. 8, the chart animation module 100 starts to move the second and third columns before it has finished placing the fourth column.

A eighth selection defines whether or not highlighting is performed in anticipation of the movement of constituent elements. For example, in FIG. 6, the chart animation module 100 can highlight a particular column prior to removal of that column. In FIG. 7, the chart animation module 100 can highlight a particular row prior to removing that row. The highlighting helps draw the user's attention a change that is being made to the first chart to produce the second chart.

An ninth selection defines whether or not the chart animation module 100 creates ghost images to designate the former positions of constituent elements that have been removed from the first chart. A ghost image may correspond to a semi-transparent or grayed-out version of a constituent element that has been removed. For example, FIG. 8 indicates the presence of such ghost images by dashed lines. This behavior is another feature that helps the user understand the changes that are being made to the first chart to produce the second chart.

The above-described configuration options are presented by way of example, not limitation. Other implementations can introduce additional configuration options and/or omit one or more of the options defined above.

B. Illustrative Processes

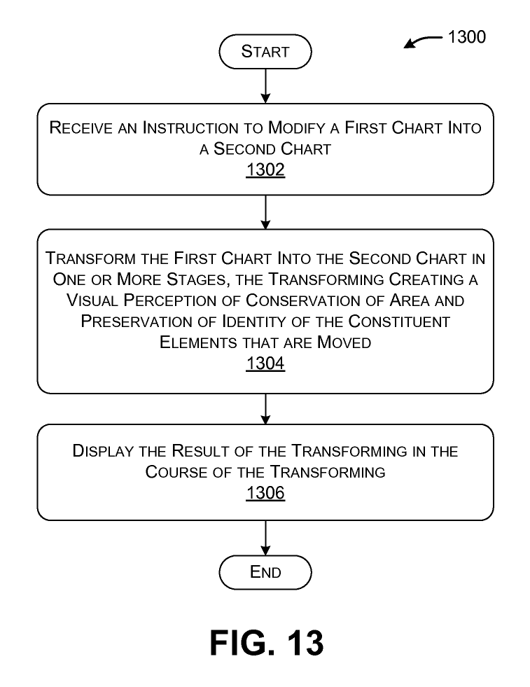

FIG. 13 shows an illustrative procedure 1300 that explains one manner of operation of the chart animation module 100 of FIG. 1. Since the principles underlying the operation of the chart animation module 100 have already been described in Section A, the operations will be addressed in summary fashion in this section.

In block 1302, the chart animation module 100 receives an instruction by a user, which commands it to transform a first chart into a second chart. For example, the user can instruct the chart animation module 100 to perform a grouping-type transformation, a filtering-type transformation, or a transposing-type transformation, etc. In block 1304, the chart animation module 100 carries out the instructed transformation. The chart animation module 100 performs this transformation in such a manner so as to give an observer the perception that the areas and identities of constituent elements are being preserved (in the course of their movement). In a first case, the chart animation module 100 may literally (e.g., mathematically) conserve the areas. In a second case, the chart animation module 100 may not literally conserve the areas (e.g., because of various environment-specific zooming-in and zooming-out may also be performed), but it nonetheless appears to the observer as if the areas are conserved. In block 1306, the chart animation module 100 displays an animated result of the transforming (in block 1304) over the course of that transforming.

C. Representative Computing Functionality

FIG. 14 sets forth illustrative computing functionality 1400 that can be used to implement any aspect of the functions described above. For example, the computing functionality 1400 can be used to implement any aspect of the chart animation module 100 of FIG. 1, e.g., as implemented in the embodiments of FIG. 2 or FIG. 3, or in some other embodiment. In one case, the computing functionality 1400 may correspond to any type of computing device that includes one or more processing devices. In all cases, the computing functionality 1400 represents one or more physical and tangible processing mechanisms.

The computing functionality 1400 can include volatile and non-volatile memory, such as RAM 1402 and ROM 1404, as well as one or more main processing devices 1406 (e.g., one or more CPUs) and/or one or more graphical processing units 1408. The computing functionality 1400 also optionally includes various media devices 1410, such as a hard disk module, an optical disk module, and so forth. The computing functionality 1400 can perform various operations identified above when the processing device(s) (1406, 1408) execute instructions that are maintained by memory (e.g., RAM 1402, ROM 1404, or elsewhere).

More generally, instructions and other information can be stored on any computer readable medium 1412, including, but not limited to, static memory storage devices, magnetic storage devices, optical storage devices, and so on. The term computer readable medium also encompasses plural storage devices. In all cases, the computer readable medium 1412 represents some form of physical and tangible entity.

The computing functionality 1400 also includes an input/output module 1414 for receiving various inputs (via input modules 1416), and for providing various outputs (via output modules). One particular output mechanism may include a presentation module 1418 and an associated graphical user interface (GUI) 1420. The computing functionality 1400 can also include one or more network interfaces 1422 for exchanging data with other devices via one or more communication conduits 1424. One or more communication buses 1426 communicatively couple the above-described components together.

The communication conduit(s) 1424 can be implemented in any manner, e.g., by a local area network, a wide area network (e.g., the Internet), etc., or any combination thereof The communication conduit(s) 1424 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by physical and tangible computing functionality, for animating transitions between chart states, comprising:
receiving an instruction to modify a first chart into a second chart,
the first chart showing a plurality of first aggregate results,
the second chart showing a plurality of second aggregate results,
the first aggregate results comprising a plurality of constituent elements, and
the second aggregate results including at least a subset of the plurality of constituent elements in the first aggregate results,
transforming the first chart into the second chart based on the instruction, said transforming creating a visual perception of conservation of area and preservation of identity of the subset of constituent elements as said subset of constituent elements transition from the first chart to the second chart; and
displaying an animated result of said transforming on an output device as said transforming is being performed,
said receiving, transforming, and displaying being performed by the computing functionality.

2. The method of claim 1, wherein the first chart comprises a first stacked bar chart, and wherein the second chart comprises a second stacked bar chart, the second stacked bar chart representing a transformation of the first stacked bar chart.

3. The method of claim 1,
wherein the instruction comprises a grouping-type instruction, and
wherein said transforming involves adding component aggregate results to the first aggregate results to produce the second chart, or removing component aggregate results from the first aggregate results to produce the second chart.

4. The method of claim 1,
wherein the instruction comprises a filtering-type instruction,
wherein the first aggregate results include a plurality of rows and columns of the plurality of constituent elements, and
wherein said transforming involves sweeping out at least one row from the first chart and collapsing remaining rows in the first chart, or adding at least one new row to the first chart, to thereby produce the second chart.

5. The method of claim 1,
wherein the instruction comprises a filtering-type instruction,
wherein the first aggregate results include a plurality of rows and columns of the plurality of constituent elements, and
wherein said transforming involves sweeping out at least one column from the first chart and collapsing remaining columns in the first chart, or adding at least one new column to the first chart, to thereby produce the second chart.

6. The method of claim 1,
wherein the instruction comprises a transposing-type instruction,
wherein the first aggregate results express a first manner of organizing group categories and the second aggregate results express a second manner of organizing group categories, and
wherein said transforming involves moving the subset of the constituent elements to respective positions in the second aggregate results from original respective positions in the first aggregated results.

7. The method of claim 1, wherein said displaying involves depicting movement of constituent elements as movement of blocks, each block representing a component aggregate result in the first chart.

8. The method of claim 1, wherein said displaying involves depicting movement of constituent elements as movement of particles, each component aggregate result in the first chart being composed of a plurality of particles.

9. The method of claim 1, wherein said transforming involves transforming the first chart into the second chart in a single display area.

10. The method of claim 1, wherein the first chart is associated with a first display area and the second chart is associated with a second display area, and wherein said transforming involves moving the subset of constituent elements from the first display area to the second display area.

11. The method of claim 1, wherein said displaying involves highlighting at least one constituent element in the first chart prior to removal of said at least one constituent element from the first chart.

12. The method of claim 1, wherein said displaying involves displaying a ghost image of at least one constituent element that has been removed from the first chart.

13. The method of claim 1, wherein said transforming is governed by a movement schedule, the movement schedule defining a timing at which constituent elements in a collection of constituent elements are removed from the first chart to produce the second chart.

14. The method of claim 13, wherein:
a first movement schedule organizes movement of the collection of constituent elements by treating each constituent element individually;
a second movement schedule organizes movement of the collection of constituent elements by moving respective rows of the collection of constituent elements; and
a third movement schedule organizes movement of the collection of constituent elements by moving respective columns of the collection of constituent elements.

15. The method of claim 1, wherein said transforming is governed by a selectable in-play parameter, the in-play parameter defining how many of the constituent elements are being moved at any given time.

16. The method of claim 1, wherein said transforming is performed, at least in part, by at least one graphical processing unit of the computing functionality.

17. A chart animation module, implemented by physical and tangible computing functionality, for animating transitions between chart states, comprising:
a transition selection module for receiving an instruction to modify a first chart into a second chart,
the first chart showing a plurality of first aggregate results,
the second chart showing a plurality of second aggregate results,
the first aggregate results comprising a plurality of constituent block elements, and
the second aggregate results including at least a subset of the plurality of constituent block elements; and
a chart transition module for:
transforming the first chart into the second chart in one or more stages based on the instruction, said transforming creating a visual perception of conservation of size and area, and preservation of identity, of the subset of constituent block elements as said subset of constituent block elements transition from the first chart to the second chart; and
displaying an animated result of said transforming on an output device as said transforming is being performed.

18. The chart animation module of claim 17, wherein the chart transition module includes:
a grouping module for executing a grouping-type transformation whereby component aggregate results are added to, or removed from, the first aggregate results to produce the second aggregate results;
a filtering module for executing a filtering-type transformation whereby a group of constituent elements are removed from, or added to, the first aggregate results to produce the second aggregate results; and
a transposing module for executing a transposing-type transformation whereby a first manner of organizing group categories in the first aggregate results is changed into a second manner of organizing group categories in the second aggregate results.

19. A computer readable storage medium for storing computer readable instructions, the computer readable instructions providing a chart animation module when executed by one or more processing devices, the computer readable instructions comprising:
logic for receiving an instruction to modify a first chart into a second chart,
the first chart showing a plurality of first aggregate results,
the second chart showing a plurality of second aggregate results,
the first aggregate results comprising a plurality of constituent elements, and
the second aggregate results including at least a subset of the plurality of constituent elements,
logic for transforming the first chart into the second chart, said transforming involving sweeping a plurality of particles associated with the subset of constituent elements from the first aggregate results to the second aggregate results,
logic for displaying an animated result of said transforming on an output device as said transforming is being performed.

20. The computer readable storage medium of claim 19, wherein said logic for transforming is governed by a selectable movement schedule, the selectable movement schedule defining a timing at which constituent elements in a collection of constituent elements are removed from the first chart to produce the second chart, wherein:
a first movement schedule organizes movement of the collection of constituent elements by treating each constituent element individually;
a second movement schedule organizes movement of the collection of constituent elements by moving respective rows of the collection of constituent elements; and
a third movement schedule organizes movement of the collection of constituent elements by moving respective columns of the collection of constituent elements.
